(19) United States
(12) Patent Application Publication
(10) Pub. No.: US 2022/0155419 A1
(43) Pub. Date: May 19, 2022

(54) OPTICAL PHASE ARRAY ANTENNA BASED ON OPTICAL WAVEGUIDE HAVING DOUBLE GRATING STRUCTURE AND LIDAR INCLUDING THE SAME

(71) Applicant: GIST (Gwangju Institute of Science and Technology), Gwangju (KR)

(72) Inventors: Nan Ei YU, Gwangju (KR); Byeong Chan PARK, Gwangju (KR)

(73) Assignee: GIST (Gwangju Institute of Science and Technology), Gwangju (KR)

(21) Appl. No.: 17/502,215

(22) Filed: Oct. 15, 2021

(30) Foreign Application Priority Data
Nov. 19, 2020 (KR) 10-2020-0156049

(51) Int. Cl. G01S 7/481; G02F 1/295

(52) U.S. Cl. CPC G01S 7/4814; G02F 1/2955

(57) ABSTRACT

Provided is an optical phase array antenna including a coupling part configured to receive light from a laser generator, an optical distributor configured to distribute the light transmitted from the coupling part to a plurality of antenna element waveguides, a phase modulator configured to modulate a phase of the light transmitted through the plurality of antenna element waveguides, and a light outputter configured to output the light modulated by the phase modulator, the light outputter including the plurality of antenna element waveguides extending in one direction, wherein each of the plurality of antenna element waveguides includes a double grating antenna part in which a downward-curved portion curved downward from an upper surface and an upward-curved portion curved upward from a lower surface are repeatedly formed in the one direction.

### CROSS-REFERENCE TO RELATED APPLICATION

This application claims priority to and the benefit of Korean Patent Application No. 2020-0156049, filed on Nov. 19, 2020, the disclosure of which is incorporated herein by reference in its entirety.

### BACKGROUND

### 1. Field of the Invention

The present disclosure relates to an optical phase array antenna employing an optical waveguide having a double grating structure, and a light detection and ranging (LiDAR) including the same.

### 2. Discussion of Related Art

A light detection and ranging (LiDAR) sensor for use in an autonomous vehicle measures a time required to receive a reflected pulse laser beam when a pulse laser beam is incident on an object so as to obtain three-dimensional (3D) spatial information. Laser emission methods are largely divided into a “flash method” and a “scanning method”. The flash method is a method of simultaneously injecting laser beams into a wide area, in which a light-receiving element is in a two-dimensional (2D)-array form to allow a receiver to identify a reflected image. In contrast, a LiDAR employing the scanning method performs point mapping on a 3D space through rotation of laser beams in vertical and horizontal directions. Therefore, in the scanning method, a laser light source output is lower and a receiver and a light-receiving element have simpler configurations than when the flash method is employed. A LiDAR employing a scanning method of the related art measures a viewing angle of 360° through mechanical motor rotation.

However, an existing mechanical LiDAR includes a rotating motor that is heavy in weight and consumes a large amount of power and thus cannot be used in an unmanned flight vehicle requiring limited power and weight, and a mechanical rotational speed thereof does not correspond to a rotational speed required for driving of an autonomous vehicle on an express way.

An optical phase array antenna may distribute laser beams incident thereon to antenna elements through several directional coupling parts and modulate phases of the distributed laser beams to achieve a desired output laser traveling direction.

In order to increase a maximum distance to be measured by the LiDAR, an antenna requires a higher laser output but a silicon waveguide having low laser threshold power and high linear or nonlinear loss is disadvantageous compared to a silicon nitride waveguide.

The silicon nitride waveguide can easily interact with adjacent waveguides having the same propagation constant because the size of an evanescent wave increases in a waveguide mode due to a low refractive index. In order to increase a limited horizontal viewing angle of an optical phase array antenna, a distance between antenna elements should be close to a distance corresponding to half a wavelength (λ/2), but as the distance between the antenna elements becomes shorter, a desired output phase distribution can be more difficult to achieve due to crosstalk between the antenna elements.

In the case of a LiDAR designed to be mounted in an autonomous vehicle, the LiDAR should be operated normally regardless of a temperature change (−40° C. to 85° C.) in the autonomous vehicle for the safety of passengers and pedestrian safety and thus it is difficult to use a phase change through local heating of a silicon nitride waveguide.

Due to a process performed on a wafer, in a flat optical element, the directivity of a laser output from a chip is difficult to achieve due to a vertical refractive index symmetry, and therefore, laser beams output isotropically are reflected from a bottom surface of the flat optical element and thus interfere with laser beams traveling upward, thereby causing a change of a propagation direction of output laser beams and generating noise.

As the related art of an optical phase array antenna, Korean registered Patent No. 10-1924890 filed in the name of the present applicant and entitled “Optical Phase Array Antenna and LiDAR Including the Same” is disclosed. The related art discloses a structure formed by changing the height of an antenna element waveguide of a light outputter, the structure including a plurality of diffraction gratings formed to be greater in height than the antenna element waveguide and to be spaced apart from each other. Through the structure, incident laser beams may be output in a desired direction without using a mechanical driving device, and effects due to an external environmental change can be minimized.

However, in recent years, there is a growing need for an optical phase array antenna having improved transmittance and directivity.

### SUMMARY

The present disclosure has been made to solve the above problems.

First, the present disclosure is directed to an optical phase array antenna structure designed to develop a light detection and ranging (LiDAR) sensor, which is configured for autonomous driving based on an optical phase array antenna and an unmanned flight vehicle, replace mechanical rotation according to the related art, is lighter and cheaper, and is mass-producible.

Second, the present disclosure is directed to an optical phase array antenna structure having improved transmittance and directivity compared with the related art.

Third, the present disclosure is directed to an optical phase array antenna structure that may be produced by complementary metal-oxide semiconductor (CMOS) semiconductor process technology, have a maximum output of 2 W or more, and increase a noise-to-signal ratio through modification of a structure of an optical phase array antenna satisfying a viewing angle of 120°.

According to an embodiment of the present disclosure, an optical phase array antenna includes a coupling part configured to receive light from a laser generator, an optical distributor configured to distribute the light transmitted from the coupling part to a plurality of antenna element waveguides, a phase modulator configured to modulate a phase of the light transmitted through the plurality of antenna element waveguides, and a light outputter configured to output the light modulated by the phase modulator, the light outputter including the plurality of antenna element waveguides extending in one direction, wherein each of the plurality of antenna element waveguides includes a double grating antenna part in which a downward-curved portion curved downward from an upper surface and an upward-curved portion curved upward from a lower surface are repeatedly formed in the one direction.

Each of the plurality of antenna element waveguides may further include a flat waveguide part, the upper surface and lower surface of which are at the same height and extend in the one direction, and the flat waveguide part and the double grating antenna part may be sequentially provided in the one direction.

In the double grating antenna part, a first depth, which is a depth of the downward-curved portion, may be greater than a second depth, which is a depth of the upward-curved portion, in a vertical direction.

In the double grating antenna part, a first length, which is a length of the downward-curved portion, may be greater than a second length, which is a length of the upward-curved portion, in the one direction.

The double grating antenna part may include an overlapping region in which the upward-curved portion and the downward-curved portion overlap to communicate with each other in the vertical direction, and the overlapping region may include a hole.

The upward-curved portion and the downward-curved portion may each have a vertical quadrilateral cross section.

The upward-curved portion and the downward-curved portion may be repeatedly formed in pitches within a certain distance in the direction, and the pitch of the upward-curved portion and the pitch of the downward-curved portion may be the same distance in the one direction.

A radiation angle θ of light, which is output through the light outputter, in a forward direction of the light to the vertical direction, an effective refractive index (n_{eff}) of a mode, a background refractive index (n_{background}), an operating wavelength λ, and pitches Λ of the upward-curved portion and the downward-curved portion may satisfy the following Equation 1:

$$Sin ( θ ) = \frac{{n}_{eff} - \frac{λ}{Λ}}{{n}_{background}}$$

In the double grating antenna part, a lower layer and an upper layer may be stacked, and the downward-curved portion may be formed by etching an upper portion of the upper layer, and the upward-curved portion may be formed by etching a lower portion of the lower layer.

According to another embodiment of the present disclosure, a method of fabricating a double grating antenna part of the optical phase array antenna includes (a) preparing a silicon-on-insulator (SOI) on which a first layer to a third layers are stacked, (b) etching the third layer to form the upward-curved portion on the third layer, (c) depositing silicon oxide (SiO₂) on the third layer, (d) etching the silicon oxide (SiO₂) deposited on the third layer in operation (c) to planarize the silicon oxide (SiO₂) to be formed at a height corresponding to an upper surface of the third layer, (e) depositing a fourth layer on the upper surface of the third layer etched in operation (d), (f) etching the fourth layer to form the downward-curved portion on the fourth layer, and (g) depositing silicon oxide on the fourth layer, wherein the lower layer is the third layer etched in operation (b), and the upper layer is the fourth layer etched in operation (f).

In operation (e), the third and fourth layers may each be formed of silicon nitride (Si₃N₄).

After operation (a) and before operation (b), the method may further include: (a1) coating the third layer with an electron resist (ER) to form the upward-curved portion, and (a2) emitting electron-beams (E-beams) to a predetermined part coated with the ER in operation (a1) to etch the ER so as to have a shape corresponding to the upward-curved portion, and wherein operation (b) may include etching the third layer using the shape of the ER etched in operation (a2).

After operation (e) and before operation (f), the method may further include: (e1) coating the fourth layer with an ER to form the downward-curved portion, and (e2) emitting E-beams to a predetermined part of the ER coated in operation (e1) to etch the ER so as to have a shape corresponding to the upward-curved portion, and operation (f) may include etching the fourth layer using the shape of the ER etched in operation (e2).

According to another embodiment of the present disclosure, a LiDAR includes a laser generator, the optical phase array antenna, a light receiver configured to receive light reflected from an object after light is emitted from the optical phase array antenna, and a signal processor configured to process a signal received by the light receiver.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a schematic perspective view of an optical phase array antenna according to the present disclosure;

FIG. 2 is a schematic perspective view of the optical phase array antenna of FIG. 1 when viewed in a Y-axis direction;

FIG. 3 illustrates a state of the optical phase array antenna of FIG. 1 when viewed in the Y-axis direction;

FIG. 4 is a graph showing transmittance of an upper side of an optical phase array antenna when steered according to a wavelength;

FIG. 5 is a graph showing beam directionality of a light detection and ranging (LiDAR) according to a wavelength;

FIG. 6 is a graph showing reflected light according to a wavelength;

FIG. 7 is a conceptual diagram of an optical phase array antenna according to the present disclosure;

FIG. 8 is a schematic diagram illustrating a structure of an optical phase array antenna according to the present disclosure;

FIG. 9 is a schematic diagram illustrating a coupler of an optical distributor of an optical phase array antenna according to the present disclosure;

FIG. 10 shows a state of the coupling part of FIG. 9 when viewed in a Z-axis direction;

FIG. 11 shows a state of the coupling part of FIG. 9 when viewed in a Y-axis direction;

FIG. 12 is a schematic diagram of a multi-mode interferometer (MMI) included in an optical distributor of an optical phase array antenna according to the present disclosure;

FIG. 13 is a schematic diagram illustrating a state in which a metal heater is included in an optical phase array antenna according to the present disclosure;

FIG. 14 is a flowchart of a method of fabricating a double grating antenna part of an optical phase array antenna according to the present disclosure; and

FIG. 15 is a schematic diagram illustrating a process flow of the method of FIG. 14.

### DETAILED DESCRIPTION

Hereinafter, an optical phase array antenna employing an optical waveguide having a double grating structure according to the present disclosure will be described with reference to the accompanying drawings. As used herein, ‘one direction’ is illustrated as an ‘X-axis direction’ in the drawings and should be understood to mean a longitudinal direction of an optical phase array antenna according to the present disclosure. In the drawings, ‘width direction’ is illustrated as a ‘Y-axis direction’ and a ‘height direction’ is illustrated as a ‘Z-axis direction’. However, the directions defined herein are defined merely for convenience of understanding and thus the present disclosure is not limited thereby.

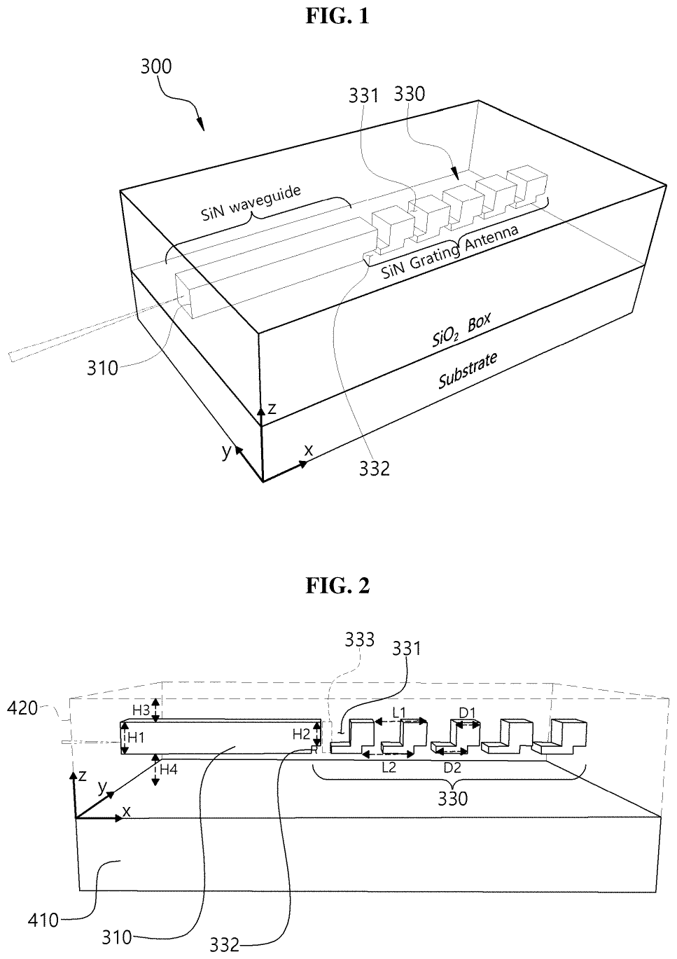

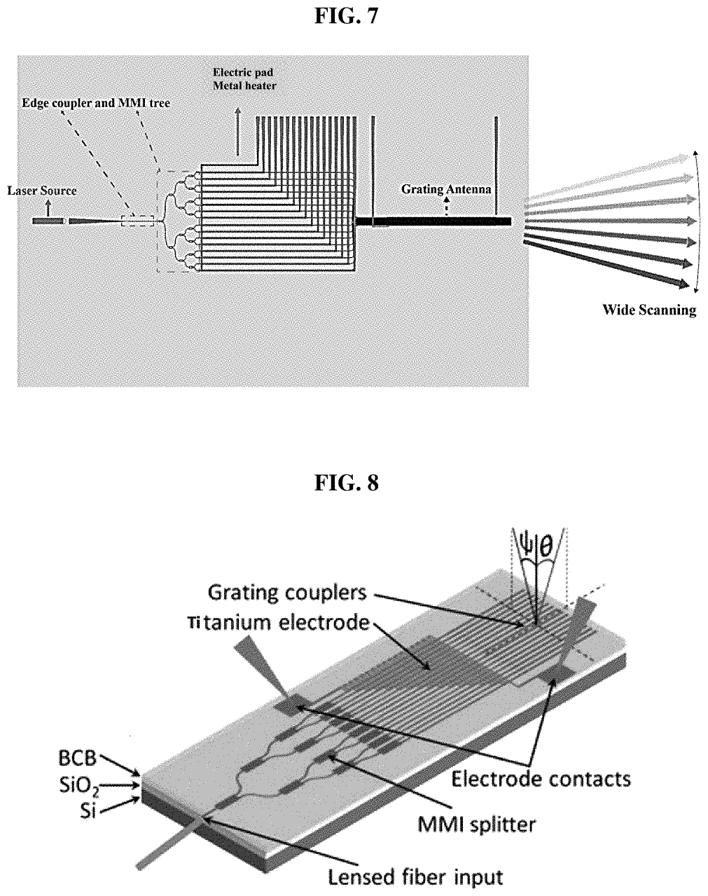

An optical phase array antenna according to the present disclosure will be described with reference to FIGS. 1 to 3, and components thereof will be described in conjunction with FIGS. 7 and 8.

The optical phase array antenna according to the present disclosure includes a coupling part, an optical distributor, a phase modulator, and a light outputter.

The optical phase array antenna and a laser generator configured to supply laser beams to the optical distributor of the optical phase array antenna may form a laser transmission module of a light detection and ranging (LiDAR). A LiDAR according to the present disclosure may further include a laser receiving module for receiving light reflected from an object after light is emitted from the laser transmission module to the outside.

The laser generator may be configured to change a wavelength of a generated laser beam and may be, for example, a tunable laser diode. A laser beam output from the optical phase array antenna to the outside may be rotated in one direction by changing a wavelength of a laser beam supplied to the optical phase array antenna.

Referring to FIG. 8, an optical distributor divides and transmits light, which is input to a coupling part, to a plurality of antenna element waveguides. The optical distributor may include a plurality of couplers. As a coupler of the optical distributor, a multi-mode interferometer (MMI), a Y-junction coupler, a directional coupler, or the like may be used. Here, the MMI is illustrated in FIG. 12.

The phase modulator modulates a phase of light distributed to each antenna element waveguide of the optical distributor. In other words, a phase of light transmitted through the antenna element waveguide may be modulated by a phase modulator and thus a laser beam output from a light outputter may be rotated about an X-axis. Although not specifically shown in the drawings of the present disclosure, the phase modulator may apply a potential using an electrode to form an electric field, thereby modulating a phase of light. However, other various methods of modulating a phase of light are applicable, in addition to the above-described method. Silicon oxide, silicon, silicon oxide, and a silicon substrate are stacked sequentially from the top in a structure necessary for the phase modulator, an antenna element waveguide is surrounded by silicon, and a grating is formed by etching silicon oxide.

In this case, the silicon on the structure has a high refractive index, thus increasing an effective refractive index of a hybrid waveguide and reducing a mode size but a thickness thereof may be set to 120 nm or less to minimize nonlinear loss due to 2-photon absorption.

The light outputter maintains a phase distribution modulated by the phase modulator to output a laser beam upward. Referring to FIGS. 7 and 8, the light outputter outputs laser beams from an X-Y plane in the Z-axis direction, and a direction in which the laser beams are output from the light outputter is steered according to a wavelength of a laser beam input to the optical distributor and a phase modulated by the phase modulator.

In this regard, referring to FIG. 8, a radiation angle θ of light output through the light outputter from a forward direction to a vertical direction may be controlled by Equation 1 below.

$$Sin ( θ ) = \frac{{n}_{eff} - \frac{λ}{Λ}}{{n}_{background}}$$

As can be seen from Equation 1 above, the radiation angle θ may be calculated by inputting an effective refractive index n_{eff} of a mode, a background refractive index n_{background}, an operating wavelength λ, and pitches Λ of an upward-curved portion and a downward-curved portion.

In the light outputter, an optimal waveguide width should be used to reduce the distances between antenna element waveguides, but when the waveguide width is large, the size of an evanescent wave may be reduced, but the distances between elements should be compensated for. For directional emission to upper parts of antenna elements, a diffraction grating formed by periodically changing a thickness of a silicon layer of a hybrid waveguide is used. In this case, due to a change of the thickness of the silicon layer, a phase change occurring in thin and thick portions satisfies constructive interference in an upward direction and destructive interference in a downward direction, thereby allowing directional emission in the upward direction. Thicknesses of upper and lower silicon oxide thin films surrounding the hybrid waveguide are set to be close to a multiple of half a waveguide to satisfy constructive interference.

In addition, a maximum thickness of the silicon layer that is periodically changed to eliminate symmetry of a vertical refractive index may be greater than that of the receiver or the phase modulator, and silicon nitride having a higher refractive index than that of silicon oxide may be used as a material covering an upper part of the waveguide instead of silicon oxide according to an environment in which LiDAR is used.

The diffraction grating of the antenna element may use a change of a width of the hybrid waveguide, and a distance between adjacent waveguides may be maintained constant when the width is changed alternately in left and right directions, and a difference between widths of adjacent waveguides changes (becomes large, small, and large) when the width is changed while crossing a neighboring waveguide, thereby reducing a degree of crosstalk caused by an evanescent wave due to a different propagation constant. In addition, when a large amount of output is required within a short distance, antenna element waveguides may be disposed discontinuously.

Referring back to FIGS. 1 to 3, a configuration of an optical phase array antenna according to the present disclosure will be described in detail. Layers of the optical phase array antenna will be described separately below.

An antenna element waveguide 300 of the optical phase array antenna according to the present disclosure includes a double grating antenna part 330 in which a downward-curved portion 331 curved downward from an upper surface and an upward-curved portion curved upward from a lower surface are alternately and repeatedly formed in one direction (an X-axis direction).

The antenna element waveguide 300 may be largely divided into a flat waveguide part 310 and the double grating antenna part 330. Here, the flat waveguide part 310 and the double grating antenna part 330 are sequentially located on a line extending in one direction. The flat waveguide part 310 has a certain length, and units 330a, 330b, and 330c each having a three-dimensional (3D) shape are repeatedly provided in the double grating antenna part 330 in one direction. The flat waveguide part 310 and the double grating antenna part 330 may be formed as a bar formed of silicon nitride (Si₃N₄). The antenna element waveguide 300 of the present disclosure is disposed on a substrate 410, which is a so-called wafer, and is embedded while being surrounding by silicon oxide (SiO₂) 420. Here, upper and lower surfaces of the flat waveguide part 310 and the double grating antenna part 330 may be at the same height, and optical values may be selected by a designer as a distance H3 from the upper surface to the silicon oxide 420 and a distance H4 from the lower surface to the substrate 410.

As described above, the double grating antenna part 330 includes the downward-curved portion 331 and the upward-curved portion 332. Here, the downward-curved portion 331 refers to a space curved downward to a certain depth from the upper surface, and the upward-curved portion 332 refers to a space curved upward to a certain depth from the lower surface.

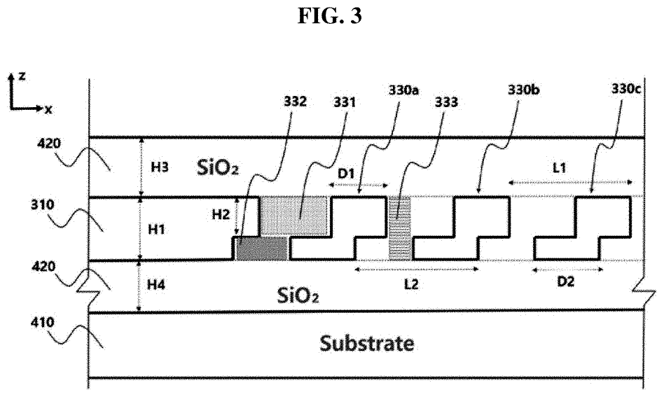

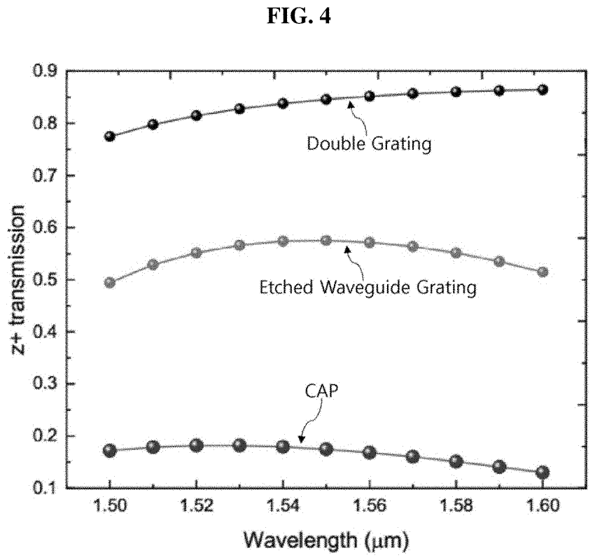

Referring to FIGS. 2 and 3, the downward-curved portion 331 and the upward-curved portion 332 of the double grating antenna part 330 of the present disclosure are both formed as a cavity, but shapes thereof are slightly different from each other.

A flat waveguide part 310 and the double grating antenna part 330 may be at the same height H1. A depth of the downward-curved portion 331 is ‘H2’, and a depth of the upward-curved portion 332 may be derived as ‘the difference between H1 and H2’. In this case, in the double grating antenna part 330, a first depth H2, which is the depth of the downward-curved portion 331, may be set to be greater than a second depth H1-H2, which is the depth of the upward-curved portion 332, in a vertical direction.

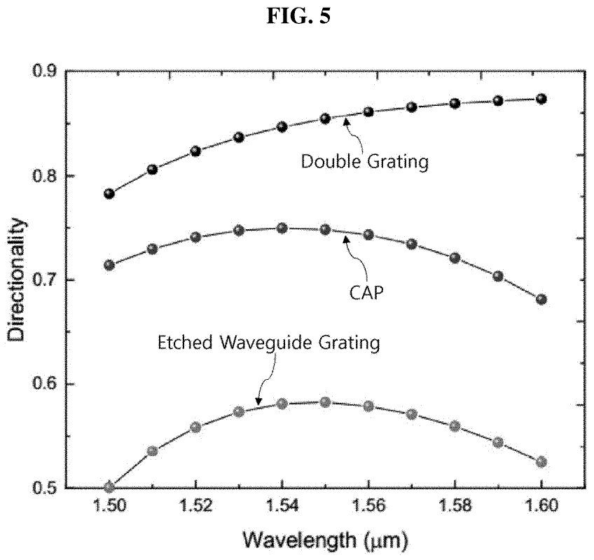

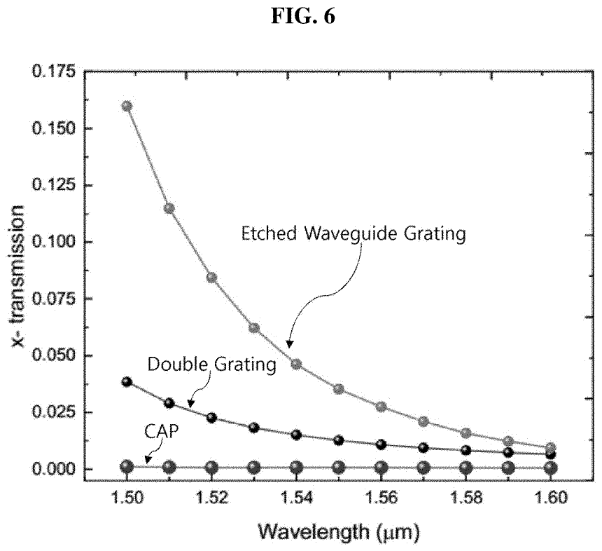

In this case, there may be a region overlapping the downward-curved portion 331 and the upward-curved portion 332 in the vertical direction. That is, the region refers to a region in which a through-hole or a hole is formed as a portion curved upward and a portion curved downward to meet together to communicate with each other and will be referred herein to as an overlapping region 333. In the optical phase array antenna of the present disclosure, the overlapping region 333 is periodically formed, thereby achieving the same effect as when a waveguide is cut periodically, and therefore, remarkable effects may be achieved in terms of transmittance, directivity of beams, and reflected light compared to structures of the related art (see FIGS. 5 to 7). Referring to FIGS. 5 and 6, the optical phase array antenna of the present disclosure has very high efficiency (z+=85%, directionality=85.5%) as compared to efficiency of an existing structure (z+=15%, directionality=70%) and efficiency of an etched waveguide grating structure (z+=55%, directionality=60%), and thus transmittance and directivity are significantly improved. Referring to FIG. 6, the optical phase array antenna has a lower degree of back reflection than that of the etched waveguide grating structure and thus is more suitable for frequency modulated continuous wave (FMCW) LiDAR.

Referring back to FIGS. 2 and 3, the downward-curved portion 331 and the upward-curved portion 332 of the antenna element waveguide of the present disclosure are alternately repeated. That is, the downward-curved portion 331 and the upward-curved portion 332 are repeatedly formed in pitches within a certain distance, and a pitch L2 of the upward-curved portion 332 and a pitch L1 of the downward-curved portion 331 may be the same distance.

In one direction, an upper end length D1 of the double grating antenna part 330 may vary according to a size of the downward-curved portion 331. A lower end length D2 of the double grating antenna part 330 may also vary according to the size of the upward-curved portion 332. In one direction, a first length L1-D1, which is a length of the downward-curved portion 331, may be set to be greater than a second length L2-D2, which is a length of the upward-curved portion 332.

In addition, a lower layer and an upper layer are stacked in the double grating antenna part 330, the downward-curved portion 331 is formed by etching an upper portion of the upper layer, and the upward-curved portion 332 is formed by etching a lower portion of the lower layer.

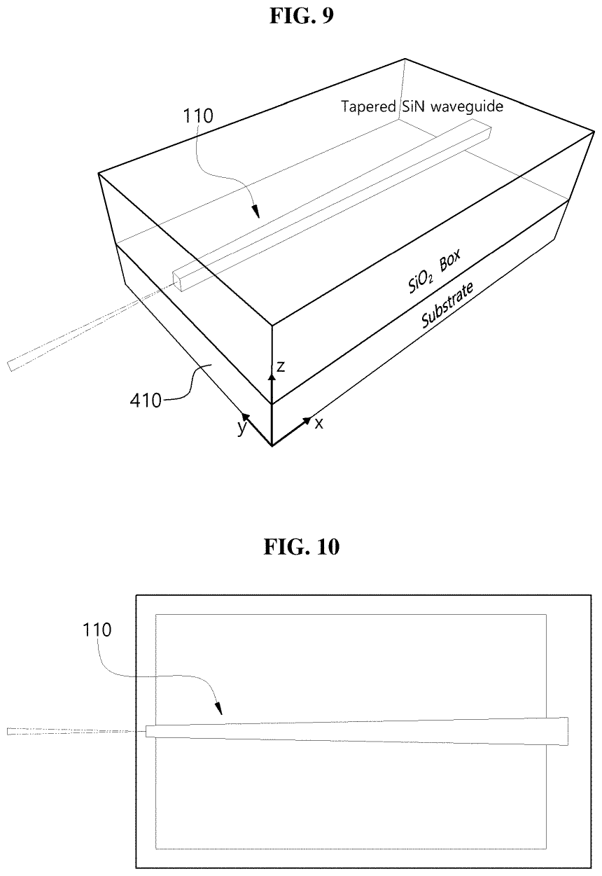

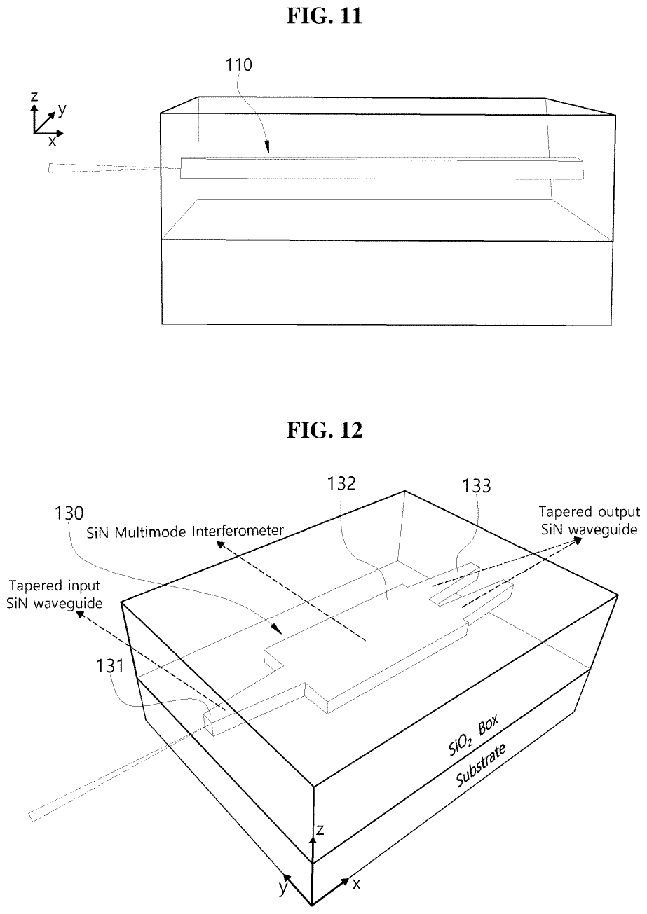

FIGS. 9 to 11 schematically illustrate a coupler of an optical distributor of an optical phase array antenna according to the present disclosure. As described above, when a laser generator is configured with a laser diode, a mode diameter of a laser beam output from the laser diode is larger than that of a waveguide of an optical phase array antenna and thus a coupling part is designed to reverse taper (such that a portion to which a laser beam is input has a narrow width and a width increases in a direction toward a phase modulator).

FIG. 12 schematically illustrates an MMI of an optical distributor of an optical phase array antenna according to the present disclosure. The MMI is a device used to divide light traveling along an antenna element waveguide. Similar to an optical fiber-chip coupler, mode matching between waveguides is important and a rhombus form may be used. In this case, a mode refers to a state in which light can travel without energy loss within a waveguide (optical fiber), and a form of the mode varies according to a material and shape of the waveguide and characteristics of light. When a mode of light incident to a waveguide does not match a mode of the waveguide, the light attenuates and disappears quickly.

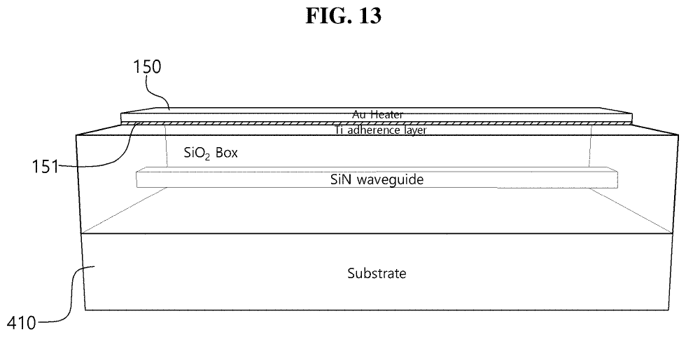

FIG. 13 schematically illustrates a state in which a metal heater is included in an optical phase array antenna according to the present disclosure. A micro-heater that changes an effective refractive index of an antenna element waveguide to change a phase of each light wave is a metal electrode having a micrometer-sized width and is heated by Joule heating due to resistance of the metal electrode when a current is supplied thereto, thereby achieving phase modulation using the thermo-optical phenomenon. For reference, one of core elements of the optical phase array antenna is a waveguide grating antenna (WGA) based on a diffraction grating having a function of emitting a beam in a direction perpendicular to a chip, and a diffraction grating structure optimized for control of directivity of the WGA is developed and manufactured to include a micro-heater for control of an emission angle.

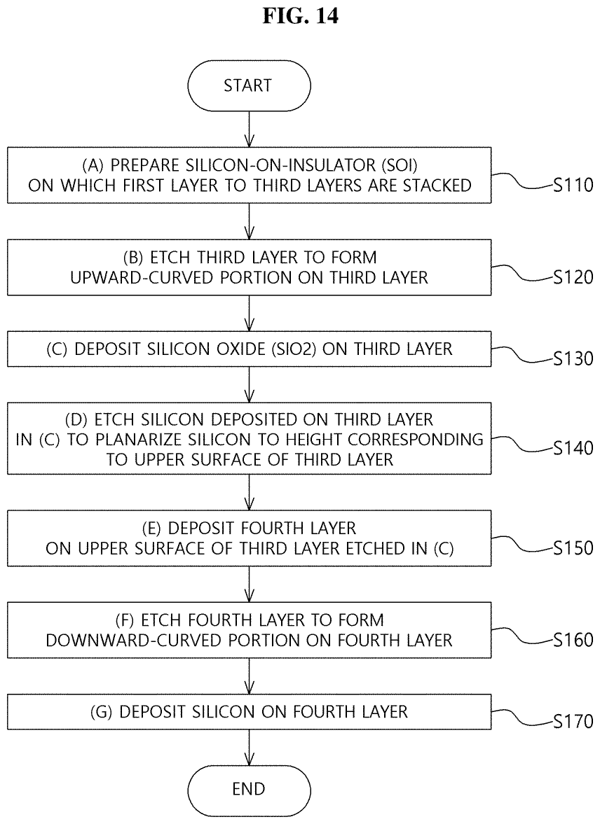

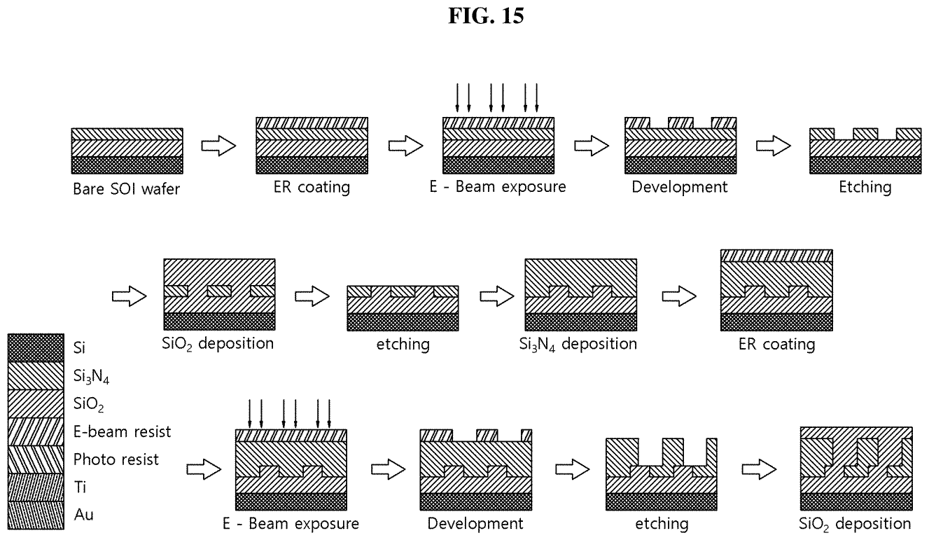

Referring to FIGS. 14 and 15, a method of fabricating a double grating antenna part of an optical phase array antenna according to the present disclosure will be described below.

The method includes operations S110 to S170.

In operation S110, a silicon-on-insulator (SOI) on which a first layer to a third layers are stacked is prepared.

In this case, after operation S110 and before operation S120, operation S111 and S112 are performed.

In operation S111, an upper surface of the third layer is coated with an electron resist (ER) to form the upward-curved portion. In operation S112, electron-beams (E-beams) are emitted to a predetermined part of the ER in operation S111 to etch the ER to a shape corresponding to the upward-curved portion. Particularly, in operation S120, the third layer is etched using the shape of the ER.

In operation S120, the third layer is etched to form the upward-curved portion in the third layer.

In operation S130, silicon oxide (SiO₂) is deposited on the third layer.

In operation S140, the silicon oxide (SiO₂) deposited on the third layer in operation S140 is etched to planarize the deposited silicon oxide (SiO₂) to a height corresponding to an upper surface of the third layer.

In operation S150, a fourth layer is deposited on the upper surface of the third layer etched in operation S140.

In this case, after operation S150 and before operation S160, operations S151 and S152 are further performed.

In operation S151, the fourth layer is coated with an ER to form a downward-curved portion.

In operation S152, E-beams are emitted to a predetermined part of the ER coated in operation S1151 to etch the ER to a shape corresponding to the upward-curved portion.

Particularly, in operation S160, the fourth layer is etched using the shape of the ER etched in operation S152.

Although the present disclosure has been described above with respect to the embodiments illustrated in the drawings, the embodiments are only examples and it will be understood by those of ordinary skill in the art that various modifications may be made and equivalent embodiments may be derived from the embodiments of the present disclosure as set forth herein. Therefore, the scope of the present disclosure should be defined by the following claims.

An optical phase array antenna of the present disclosure is expected to be available as a key element of a LiDAR sensor for use in a vehicle and to replace an existing CMOS sensor used to obtain a 3D image.

According to the present disclosure, not only an upper end of an antenna element waveguide but also a lower end thereof are etched to form a double grating, thereby maximizing upward transmittance and maximum directivity.

What is claimed is:

1. An optical phase array antenna comprising:
a coupling part configured to receive light from a laser generator;
an optical distributor configured to distribute the light transmitted from the coupling part to a plurality of antenna element waveguides;
a phase modulator configured to modulate a phase of the light transmitted through the plurality of antenna element waveguides; and
a light outputter configured to output the light modulated by the phase modulator, the light outputter including the plurality of antenna element waveguides extending in one direction,
wherein each of the plurality of antenna element waveguides comprises a double grating antenna part in which a downward-curved portion curved downward from an upper surface and an upward-curved portion curved upward from a lower surface are repeatedly formed in the one direction.

2. The optical phase array antenna of claim 1, wherein each of the plurality of antenna element waveguides further comprises a flat waveguide part, the upper surface and lower surface of which are at the same height and extend in the one direction,
wherein the flat waveguide part and the double grating antenna part are sequentially provided in the one direction.

3. The optical phase array antenna of claim 2, wherein, in the double grating antenna part, a first depth, which is a depth of the downward-curved portion, is greater than a second depth, which is a depth of the upward-curved portion, in a vertical direction.

4. The optical phase array antenna of claim 3, wherein, in the double grating antenna part, a first length, which is a length of the downward-curved portion, is greater than a second length, which is a length of the upward-curved portion, in the one direction.

5. The optical phase array antenna of claim 4, wherein the double grating antenna part comprises an overlapping region in which the upward-curved portion and the downward-curved portion overlap to communicate with each other in the vertical direction,
wherein the overlapping region comprises a hole.

6. The optical phase array antenna of claim 5, wherein the upward-curved portion and the downward-curved portion each have a vertical quadrilateral cross section.

7. The optical phase array antenna of claim 1, wherein the upward-curved portion and the downward-curved portion are repeatedly formed in pitches within a certain distance in the one direction,
wherein the pitch of the upward-curved portion and the pitch of the downward-curved portion are the same distance in the one direction.

8. The optical phase array antenna of claim 7, wherein a radiation angle θ of light, which is output through the light outputter, in a forward direction of the light to the vertical direction, an effective refractive index (n_{eff}) of a mode, a background refractive index (n_{background}), an operating wavelength λ, and pitches Λ of the upward-curved portion and the downward-curved portion satisfy the following Equation 1:
$$Sin ( θ ) = \frac{{n}_{eff} - \frac{λ}{Λ}}{{n}_{background}}$$

9. The optical phase array antenna of claim 1, wherein, in the double grating antenna part, a lower layer and an upper layer are stacked, and
the downward-curved portion is formed by etching an upper portion of the upper layer, and the upward-curved portion is formed by etching a lower portion of the lower layer.

10. A method of fabricating a double grating antenna part of the optical phase array antenna of claim 9, the method comprising:
(a) preparing a silicon-on-insulator (SOI) on which a first layer to a third layers are stacked;
(b) etching the third layer to form the upward-curved portion on the third layer;
(c) depositing silicon oxide (SiO₂) on the third layer;
(d) etching the silicon oxide (SiO₂) deposited on the third layer in operation (c) to planarize the silicon oxide (SiO₂) to be formed at a height corresponding to an upper surface of the third layer;
(e) depositing a fourth layer on the upper surface of the third layer etched in operation (d);
(f) etching the fourth layer to form the downward-curved portion in the fourth layer; and
(g) depositing silicon oxide on the fourth layer,
wherein the lower layer is the third layer etched in operation (b), and the upper layer is the fourth layer etched in operation (f).

11. The method of claim 10, wherein, in operation (e), the third and fourth layers are each formed of silicon nitride (Si₃N₄).

12. The method of claim 10, after operation (a) and before operation (b), further comprising:
(a1) coating the third layer with an electron resist (ER) to form the upward-curved portion; and
(a2) emitting electron-beams (E-beams) to a predetermined part of the ER coated in (a1) to etch the ER to a shape corresponding to the upward-curved portion, and
wherein operation (b) comprises etching the third layer using the shape of the ER etched in operation (a2).

13. The method of claim 10, after operation (e) and before operation (f) further comprising:
(e1) coating the fourth layer with an electron resist (ER) to form the downward-curved portion; and
(e2) emitting electron-beams (E-beams) to a predetermined part coated with the ER in operation (e1) to etch the ER so as to have a shape corresponding to the upward-curved portion,
wherein operation (f) comprises etching the fourth layer using the shape of the ER etched in operation (e2).

14. A laser induced detection and ranging (LiDAR) comprising:
a laser generator;
the optical phase array antenna of claim 1;
a light receiver configured to receive light reflected from an object after the light is emitted from the optical phase array antenna; and
a signal processor configured to process a signal received by the light receiver.
